(19) United States
(12) Patent Application Publication
(10) Pub. No.: US 2006/0188095 A1
(43) Pub. Date: Aug. 24, 2006

(54) Combination encoding method for simultaneously encrypting and channel encoding, transmitting apparatus thereof, combination decoding method for simultaneously channel decoding and decrypting, and receiving apparatus thereof

(75) Inventors: Tae-chul (Edward) Jung, Seongnam-si (KR); Kyung-hee Lee, Yongin-si (KR); Evgeny Krouk, St.Petersburg (RU); Evgeny Linsky, St. Petersburg (RU); Sergey Bezzateev, St. Petersburg (RU)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/360,526

(22) Filed: Feb. 24, 2006

(30) Foreign Application Priority Data
Feb. 24, 2005 (KR) 2005-0015471

(51) Int. Cl. H04L 9/00

(52) U.S. Cl. 380/46

(57) ABSTRACT

A combination encoding method, a transmitting apparatus thereof, a combination decoding method, and a receiving apparatus thereof are provided. The transmitting apparatus includes a combination encoding unit for performing combination encoding on a source coded message and outputting the combination encoded message, thereby performing encrypting and channel encoding simultaneously. The receiving apparatus includes a combination decoding unit for performing combination decoding on the noise-added combination encoded message from the demodulator, and outputting a source coded message, thereby simultaneously performing channel decoding and decrypting on the noise-added combination encoded message.

### CROSS-REFERENCE TO RELATED APPLICATIONS

This application claims benefit under 35 U.S.C. § 119 from Korean Patent Application No. 2005-15471, filed on Feb. 24, 2005, the entire contents of which is incorporated herein by reference.

### BACKGROUND OF THE INVENTION

1. Field of the Invention

The present invention relates in general to a combination encoding method, a transmitting apparatus thereof, a combination decoding method and a receiving apparatus thereof. More specifically, the present invention relates to a combination encoding method for simultaneously encrypting and channel encoding, a transmitting apparatus adopting the combination encoding method, a combination decoding method for simultaneously channel decoding and decrypting, and a receiving apparatus adopting the combination decoding method.

2. Description of the Related Art

Encrypting/decrypting and channel encoding/channel decoding are communication technologies which are developed for protecting information and for error detection/correction, respectively. A typical example of the encrypting/decrypting technology is the Rivest, Shamir, & Adleman (RSA) algorithm, and a typical example of the channel encoding/channel decoding technology is the Low Density Parity Check (LDPC).

FIG. 1 illustrates a communication system provided to explain a conventional encrypting/channel encoding and channel decoding/decrypting procedures. As shown in FIG. 1, the communication system includes a transmitting apparatus 10 and a receiving apparatus 20, which are connected to each other through a channel 30.

The transmitting apparatus 10 consists of an encrypting unit 12, a channel encoding unit 14, and a modulator 16. The encrypting unit 12 encrypts a source coded message x using the encryption algorithm. The channel encoding unit 14 performs channel encoding on the encrypted message y₁ using the channel encoding algorithm. The modulator 16 modulates the encrypted/channel encoded message y₂, and transmits a modulating signal y₂′ to the channel 30.

On the other hand, the receiving apparatus 20 consists of a demodulator 22, a channel decoding unit 24, and a decrypting unit 26. The demodulator 22 demodulates a noise-added modulating signal y₂′+e′_{channel} being received. The channel decoding unit 24 performs channel decoding on a noise-added demodulating signal y₂+e_{channel} using the channel decoding algorithm, and outputs the encrypted message y₁. The decrypting unit 26 decrypts the encrypted message y₁ using the decryption algorithm, and restores the source coded message x.

In short, in the case of the conventional transmitting apparatus 10, the encrypting unit 12 performs encrypting using the encryption algorithm, whereas the channel encoding unit 14 performs channel encoding using the channel encoding algorithm. That is, encrypting and channel encoding are carried out in two separate blocks using two separate algorithms.

Likewise, in the case of the conventional receiving apparatus 20, the channel decoding unit 24 performs channel decoding using the channel decoding algorithm, whereas the decrypting unit 26 performs decrypting using the decryption algorithm. That is, channel decoding and decrypting are carried out in two separate blocks using two separate algorithms.

Because encrypting and channel encoding are carried out in two separate blocks using two separate algorithms, the conventional transmitting apparatus 10 shows problems such as complicated message processing, reduced processing speed, and higher manufacturing cost.

Similarly, because channel decoding and decrypting are carried out in two separate blocks using two separate algorithms, the conventional receiving apparatus 20 also shows problems such as complicated message processing, reduced processing speed, and higher manufacturing cost.

### SUMMARY OF THE INVENTION

The present invention provides a combination encoding method for simultaneously encrypting and channel encoding, a transmitting apparatus adopting the combination encoding method, a combination decoding method for simultaneously channel decoding and decrypting, and a receiving apparatus adopting the combination decoding method.

According to an aspect of the present invention, there is provided a transmitting apparatus, including: a combination encoding unit for performing combination encoding on a source coded message and outputting the combination encoded message, thereby performing encrypting and channel encoding simultaneously; and a modulator for modulating the combination encoded message outputted from the combination encoding unit, and transmitting the modulated message.

The combination encoding unit includes: a first code providing part for providing a predetermined first code; an error vector providing part for providing a predetermined error vector; and an encoding part for encoding the source coded message according to the first code, adding the error vector to the encoded message, and outputting the addition result as the combination encoded message.

In an exemplary embodiment, the first code is determined based on a combination decoding error probability and a combination decoding attack probability, and the error vector is determined based on the combination decoding error probability, the combination decoding attack probability, and channel characteristics.

The first code can be a public key, and the error vector can be an encrypting error vector.

Also, the first code can be a matrix obtained by multiplying a predetermined low density parity check matrix and a predetermined non-singular matrix.

According to another aspect of the present invention, there is provided a combination encoding method including: performing combination encoding on a source coded message and outputting the combination encoded message, thereby performing encrypting and channel encoding simultaneously; and modulating the combination encoded message outputted from the combination encoding unit, and transmitting the modulated message.

The performing the combination encoding includes: encoding the source coded message according to a predetermined first code; and adding a predetermined error vector to the encoded-source coded message, and the outputting the combination encoded message comprises outputting the addition result as the combination encoded message.

The first code is determined based on a combination decoding error probability and a combination decoding attack probability, and the error vector is determined based on the combination decoding error probability, the combination decoding attack probability, and channel characteristics.

The first code can be a public key, and the error vector can be an encrypting error vector.

Also, the first code can be a matrix obtained by multiplying a predetermined low density parity check matrix and a predetermined non-singular matrix.

According to still another aspect of the present invention, there is provided a receiving apparatus, including: a demodulator for demodulating a noise-added modulating signal, and outputting a noise-added combination encoded message; and a combination decoding unit for performing combination decoding on the noise-added combination encoded message from the demodulator, and outputting a source coded message, thereby simultaneously performing channel decoding and decrypting on the noise-added combination encoded message.

The combination decoding unit includes: a second code providing part for providing a predetermined second code correspondingly to the predetermined first code used in the combination encoding method; and a decoding part for decoding the combination encoded message according to the second code, and outputting the decoding result as the source coded message.

In addition, the second code is determined based on a combination decoding error probability and a combination decoding attack probability.

The first code can be a public key, and the second code can be a private key.

Also, the first code can be a matrix obtained by multiplying a predetermined low density parity check matrix and a predetermined non-singular matrix, and the second code can be the low density parity check matrix.

Yet another aspect of the present invention provides a combination decoding method, including: demodulating a noise-added modulating signal, and outputting a noise-added combination encoded message; and performing combination decoding on the noise-added combination encoded message from the demodulator, and outputting a source coded message, thereby simultaneously performing channel decoding and decrypting on the noise-added combination encoded message.

In an exemplary embodiment, the performing the combination decoding includes: decoding the combination encoded message according to the predetermined second code corresponding to the predetermined first code used in the combination encoding method; and the outputting the noise-added combination encoding message comprises outputting the decoding result as the source coded message.

Moreover, the second code is determined based on a combination decoding error probability and a combination decoding attack probability.

The first code can be a public key, and the second code can be a private key.

Also, the first code can be a matrix obtained by multiplying a predetermined low density parity check matrix and a predetermined non-singular and the second code can be the low density parity check matrix.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 illustrates a communication system provided to explain a conventional encrypting/channel encoding and channel decoding/decrypting procedures;

FIG. 2 illustrates a communication system according to an exemplary embodiment of the present invention, in which the communication system is constituted by a transmitting apparatus for simultaneously encrypting and channel encoding, and a receiving apparatus for simultaneously channel decoding and decrypting;

FIG. 3 is a detailed block diagram of a communication system in FIG. 2;

FIG. 4A is a flow chart explaining a combination encoding method for simultaneously encrypting and channel encoding, in accordance with an exemplary embodiment of the present invention; and

FIG. 4B is a flow chart explaining a combination decoding method for simultaneously channel decoding and decrypting, in accordance with an exemplary embodiment of the present invention.

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

FIG. 2 is a block diagram of a communication system to which an exemplary embodiment of the present invention can be applied. As shown in FIG. 2, the communication system includes a transmitting apparatus 100 and a receiving apparatus 200, which are connected through a channel 300. The channel 300 is either wired or wireless.

The transmitting apparatus 100 performs encrypting and channel coding simultaneously. To this end, the transmitting apparatus 100 includes a combination encoding unit 110 and a modulator 120.

The combination encoding unit 110 performs combination encoding on a source coded message x using the combination encoding algorithm, and outputs a combination encoded message y to the modulator 120. Then, the modulator 120 modulates the combination encoded message y from the combination encoding unit 110 to generate a modulating signal y′, and transmits the modulating signal y′ to the channel 300.

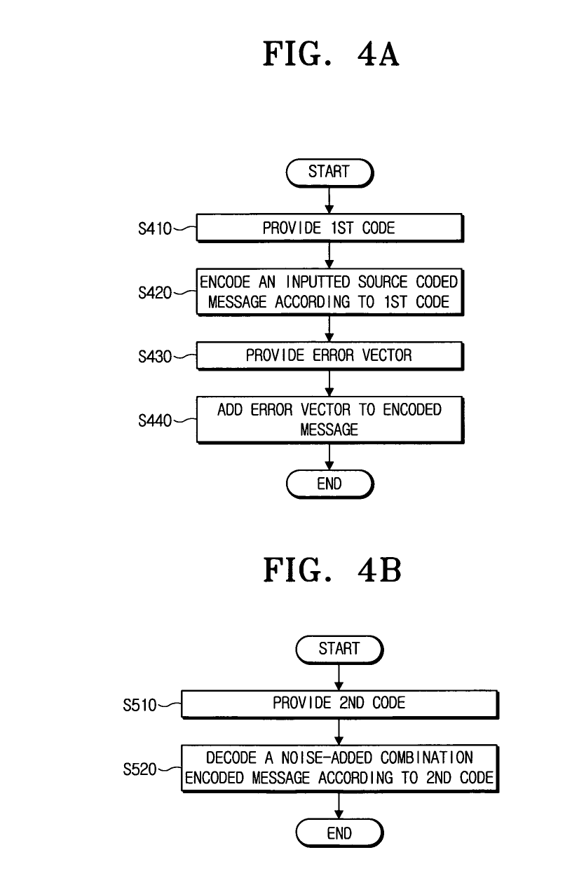

Here, ‘combination encoding’ means that encrypting and channel coding are simultaneously, not separately, performed on the source coded message x. And, ‘combination encoding algorithm’ is an algorithm for use in the combination encoding method in FIG. 4A (to be described).

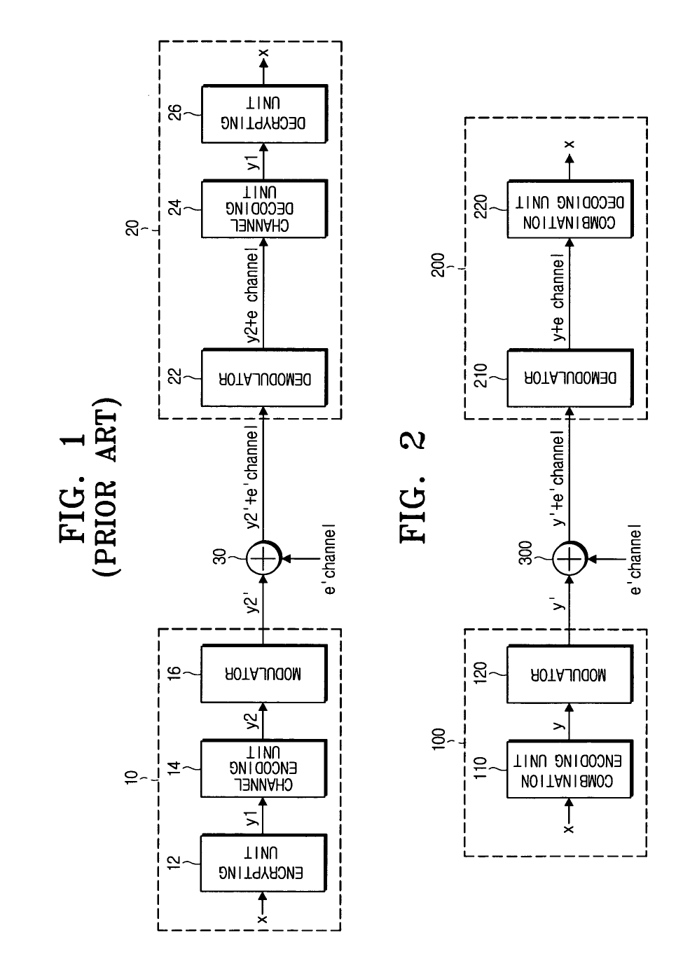

Therefore, the combination encoding unit 110 can simultaneously perform encrypting and channel encoding on the source coded message x, using only one algorithm, i.e., the combination encoding algorithm. That is, the transmitting apparatus 100 of the present invention differs from the conventional transmitting apparatus 10 of FIG. 1 in that encrypting and channel encoding are simultaneously performed in one block using only one algorithm, instead of using two separate algorithms for performing encrypting and channel encoding separately in two blocks.

For instance, as aforementioned, with respect to the conventional transmitting apparatus 10 of FIG. 1, the encrypting unit 12 performs encrypting using the encryption algorithm, and the channel encoding unit 14 performs channel encoding using the channel encoding algorithm. On the other hand, with respect to the transmitting apparatus 100 of the present invention, encrypting and channel encoding are simultaneously performed using only the combination encoding algorithm.

The receiving apparatus 200 performs channel decoding and decrypting simultaneously. To this end, the receiving apparatus 200 includes a demodulator 210, and a combination decoding unit 220.

The demodulator 210 demodulates a noise-added modulating signal y′+e′_{channel}, and outputs a noise-added combination encoded message y+e_{channel} to the combination decoding unit 220. Here, the noise-added modulating signal y′+e′_{channel} means a signal where a noise e′_{channel} of the channel 300 is added to a modulating signal y^{′}transmitted from the modulator 120 of the transmitting apparatus 100. And, the noise-added combination encoded message y+e_{channel} corresponds to a message where a demodulated noise e_{channel} is added to the combination encoded message y outputted from the combination encoding unit 110 of the transmitting apparatus 100.

The combination decoding unit 220 performs combination decoding on the noise-added combination encoded message y+e_{channel} outputted form the demodulator 210, using the combination decoding algorithm and thus, restores the source coded message x.

Here, ‘combination decoding’ means that channel decoding and decrypting are performed simultaneously, not separately, on the noise-added combination encoded message y+e_{channel}. And, the combination decoding algorithm is the counterpart of the above-described combination encoding algorithm, which is for use in the combination decoding method in FIG. 4B (to be described).

Therefore, the combination decoding unit 220 can simultaneously perform channel decoding and decrypting on the noise-added combination encoded message y+e_{channel} using only one algorithm, i.e., the combination decoding algorithm. That is, the receiving apparatus 200 of an exemplary embodiment of the present invention differs from the conventional receiving apparatus 20 of FIG. 1 in that channel decoding and decrypting are simultaneously performed in one block using only one algorithm, instead of using two separate algorithms for performing channel decoding and decrypting separately in two blocks.

For instance, as aforementioned, with respect to the conventional receiving apparatus 20 of FIG. 1, the channel decoding unit 24 performs channel decoding using the channel decoding algorithm, and the decrypting unit 26 performs decrypting using the decryption algorithm. Meanwhile, in case of the receiving apparatus 200 of the present invention, channel decoding and decrypting are simultaneously performed using only the combination decoding algorithm.

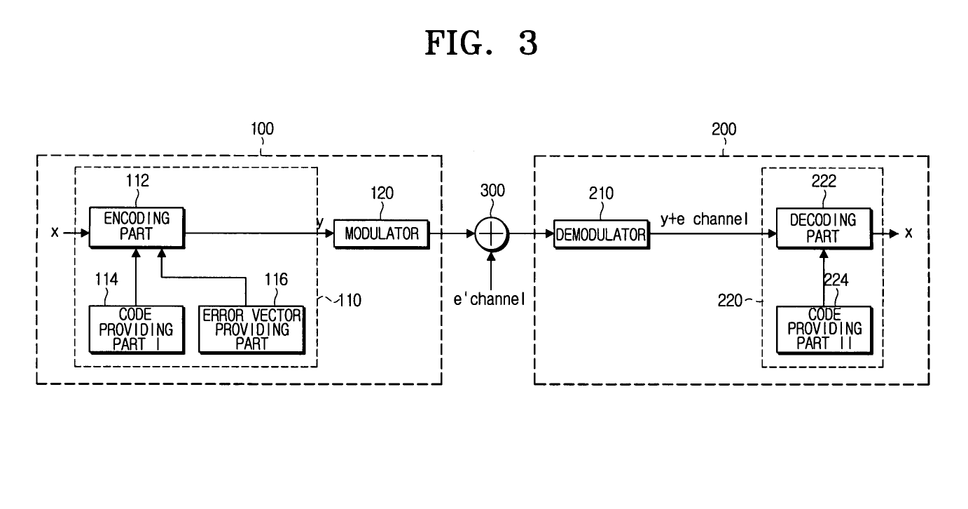

With reference to FIGS. 3 and 4A, the following explains in detail how the transmitting apparatus 100 of an exemplary embodiment of the present invention simultaneously performs encrypting and channel encoding. FIG. 3 is a detailed block diagram of the communication system in FIG. 2, and FIG. 4A is a flow chart explaining a combination encoding method for simultaneously encrypting and channel encoding, in accordance with one exemplary embodiment of the present invention.

As depicted in FIG. 3, the combination encoding unit 110 of the transmitting apparatus 100 includes an encoding part 112, a first code providing part 114, and an error vector providing part 116.

Referring to FIGS. 3 and 4A, the first code providing part 114 provides a predetermined first code to the encoding part 112 (S410). Then, the encoding part 112 encodes an inputted source coded message x according to the first code (S420).

Meanwhile, the error vector providing part 116 provides a predetermined error vector to the encoding part 112 (S430). Then, the encoding part 112 adds the error vector to the encoded message, and outputs the addition result (S440). Here, the addition result is a combination encoded message y, which is later modulated by the modulator 120 and transmitted to the channel 300.

With reference to FIGS. 3 and 4B, the following now explains in detail how the receiving apparatus 200 of the present invention simultaneously performs channel decoding and decrypting. FIG. 4B is a flow chart explaining a combination decoding method for simultaneously channel decoding and decrypting, in accordance with one exemplary embodiment of the present invention.

As shown in FIG. 3, the combination decoding unit 220 of the receiving apparatus 200 includes a decoding part 222, and a second code providing part 224.

Referring to FIGS. 3 and 4B, the second code providing part 224 provides a predetermined second code to the decoding part 222 (S510). Then, the decoding part 222 decodes an inputted noise-added combination encoded message y+e_{channel} according to the second code (S520). The decoding result in step S520 corresponds to a source coded message x being restored.

The first code and the second code used in the combination encoding method and the combination decoding method of FIGS. 4A and 4B can be determined by using a combination decoding error probability and a combination decoding attack probability, respectively.

In addition, the error vector used in the combination encoding method is an encrypting error vector e_{crypt} for encrypting the encoded message according to the first code, and can be determined by the combination decoding error probability, the combination decoding attack probability, and channel characteristics. In detail, the sum (e_{crypt}+e_{channel}) of the encrypting error vector e_{crypt} and the channel noise e_{channel} is calculated based on the combination decoding error probability and the combination decoding attack probability, in which the channel noise e_{channel} is calculated based on channel characteristics. Thus, the encrypting error vector e_{crypt} can be determined by subtracting the channel noise from the sum.

It is also possible to suppose the first code used in the combination encoding method of FIG. 4A to be a public key, and the second code used in the combination decoding method of FIG. 4B to be a private key. Furthermore, the public key G′ can be supposed to be a matrix multiplication (M×H) of a non-singular matrix M and a low density parity check matrix H. In this case, the private key is the LDPC matrix H.

The above-described combination encoding method can be expressed as an equation below.

[Equation 1]
y=xG′+e_{crypt}

As can be seen in the equation, encrypting and channel encoding are performed simultaneously.

Also, the noise-added combination encoded message y+e_{channel} that is inputted to the decoding part 222 of the combination decoding unit 220 can be expressed as an equation below.

[Equation 2]
y+e_{channel}=xG′+(e_{crypt}+e_{channel})

Then, the decrypting part 222 decrypts the right side of the Equation 2 using the private key, i.e., the LDPC matrix H, and outputs a source coded message x. Formulating the combination decoding method yields Equation 3 below.

[Equation 3]
z=(xG′+(e_{crypt}+e_{channel}))H⁻¹=xM+(e_{crypt}+e_{channel})H⁻¹
where, X=zM⁻¹

Therefore, channel decoding and decrypting can be performed simultaneously.

As explained above, according to an exemplary embodiment of the present invention, encrypting and channel encoding are performed simultaneously in one block of the transmitting apparatus using one algorithm. Likewise, channel decoding and decrypting are performed simultaneously in one block of the receiving apparatus using one algorithm. In this way, message processing is simplified and the processing speed is increased. Moreover, by reducing the number of necessary blocks, the transmitting/receiving apparatuses can be designed more simply, and this resultantly reduces the manufacturing cost.

The foregoing embodiments and aspects are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A transmitting apparatus comprising:
a combination encoding unit which performs combination encoding on a source coded message and outputs the combination encoded message, thereby performing encrypting and channel encoding simultaneously; and
a modulator which modulates the combination encoded message output from the combination encoding unit, and transmit the modulated message.

2. The transmitting apparatus according to claim 1, wherein the combination encoding unit comprises:
a first code providing part which provides a predetermined first code;
an error vector providing part which provides a predetermined error vector; and
an encoding part which encodes the source coded message according to the first code, adds the error vector to the encoded message, and outputs an addition result as the combination encoded message.

3. The transmitting apparatus according to claim 2, wherein the first code is determined based on a combination decoding error probability and a combination decoding attack probability, and the error vector is determined based on the combination decoding error probability, the combination decoding attack probability, and channel characteristics.

4. The transmitting apparatus according to claim 2, wherein the first code is a public key, and the error vector is an encrypting error vector.

5. The transmitting apparatus according to claim 4, wherein the first code is a matrix obtained by multiplying a predetermined low density parity check matrix and a predetermined non-singular matrix.

6. A combination encoding method comprising:
performing combination encoding on a source coded message and outputting the combination encoded message, thereby performing encrypting and channel encoding simultaneously; and
modulating the combination encoded message output from the combination encoding unit, and transmitting the modulated message.

7. The method according to claim 6, wherein the performing the combination encoding comprises:
encoding the source coded message according to a predetermined first code;
adding a predetermined error vector to the encoded-source coded message, and
the outputting the combination encoded message comprises outputting an addition result as the combination encoded message.

8. The method according to claim 7, wherein the first code is determined based on a combination decoding error probability and a combination decoding attack probability, and the predetermined error vector is determined based on the combination decoding error probability, the combination decoding attack probability, and channel characteristics.

9. The method according to claim 7, wherein the first code is a public key, and the error vector is an encrypting error vector.

10. The method according to claim 9, wherein the first code is a matrix obtained by multiplying a predetermined low density parity check matrix and a predetermined non-singular matrix.

11. A receiving apparatus comprising:
a demodulator which demodulates a noise-added modulating signal, and outputs a noise-added combination encoded message; and
a combination decoding unit which performs combination decoding on the noise-added combination encoded message output from the demodulator, and outputs a source coded message, thereby simultaneously performing channel decoding and decrypting on the noise-added combination encoded message.

12. The receiving apparatus according to claim 11, wherein the combination decoding unit comprises:
a second code providing part which provides a predetermined second code corresponding to the predetermined first code; and
a decoding part which decodes the combination encoded message according to the predetermined second code, and outputs the decoding result as the source coded message.

13. The receiving apparatus according to claim 12, wherein the second code is determined based on a combination decoding error probability and a combination decoding attack probability.

14. The receiving apparatus according to claim 12, wherein the first code is a public key, and the second code is a private key.

15. The receiving apparatus according to claim 14, wherein the first code is a matrix obtained by multiplying a predetermined low density parity check matrix and a predetermined non-singular matrix, and the second code is the low density parity check matrix.

16. A combination decoding method, comprising:
demodulating a noise-added modulating signal, and outputting a noise-added combination encoded message; and
performing combination decoding on the noise-added combination encoded message, and outputting a source coded message, thereby simultaneously performing channel decoding and decrypting on the noise-added combination encoded message.

17. The method according to claim 16, wherein the noise-added combination encoded message is output from a demodulator.

18. The method according to claim 16, wherein the performing the combination decoding comprises decoding the combination encoded message according to a predetermined second code corresponding to a predetermined first code; and
the outputting the source coded message comprises outputting the decoding result as the source coded message.

19. The method according to claim 18, wherein the predetermined first code is used in an encoding method.

20. The method according to claim 18, wherein the second code is determined based on a combination decoding error probability and a combination decoding attack probability.

21. The method according to claim 18, wherein the predetermined first code is a public key, and the predetermined second code is a private key.

22. The method according to claim 21, wherein the predetermined first code is a matrix obtained by multiplying a predetermined low density parity check matrix and a predetermined non-singular matrix, and the predetermined second code is the low density parity check matrix.
